(19) United States
(12) Patent Application Publication
(10) Pub. No.: US 2006/0015265 A1
(43) Pub. Date: Jan. 19, 2006

(54) Method of rapidly identifying X-ray powder diffraction patterns

(76) Inventor: Anne C. Raich, Des Plaines, IL (US)

Correspondence Address: JOHN G TOLOMEI, PATENT DEPARTMENT;UOP LLC, 25 EAST ALGONQUIN ROAD, P O BOX 5017, DES PLAINES, IL, 60017-5017, US

(21) Appl. No.: 09/947,153

(22) Filed: Sep. 5, 2001

Related U.S. Application Data
(63) Continuation-in-part of application No. 09/443,644, filed on Nov. 18, 1999, now abandoned.

(51) Int. Cl. G06F 19/00

(52) U.S. Cl. 702/22

(57) ABSTRACT

A method to rapidly identify multiple X-ray powder diffraction patterns, such as those generated through combinatorial chemistry, has been developed. More particularly, the method is directed toward measuring X-ray powder diffraction patterns of a set of materials and applying hierarchical clustering analysis to determine clusters of X-ray powder diffraction patterns that are similar. A search-match algorithm is applied to the X-ray powder diffraction patterns within a cluster to determine the several most likely structural identities of the materials forming the cluster, and correspondence factor analysis is applied to the multiple sets of possible identities to establish the most likely structural identity of all the members of the cluster.

### CROSS REFERENCE TO RELATED APPLICATION

This application is a continuation-in-part of our copending patent application Ser. No. 09/443,644 filed Nov. 18, 1999, which is hereby incorporated by reference in its entirety.

### FIELD OF THE INVENTION

This invention relates to rapidly identifying multiple X-ray powder diffraction patterns, such as those generated through combinatorial chemistry, by applying hierarchical clustering analysis, a search-match algorithm, and w correspondence factor analysis.

### BACKGROUND OF THE INVENTION

Combinatorial chemistry is being increasingly used in the formation of new compounds and in the study of catalysts and how they perform. Numerous different compounds may be formed simultaneously, and what used to take days or weeks may now be accomplished in minutes or hours. Along with the rapid synthesis of new chemical compounds and catalysts, however, comes the task of identifying the large volume of newly synthesized compounds. For many years now, the X-ray powder diffraction analytical technique has been a favorite among chemists for determining the structure of new compounds. However, the overall identification process may be time consuming, with each X-ray powder diffraction pattern being painstakingly compared to a large number of known patterns in a library. Known pattern recognition or “search and match” computer programs such as Jade 5.0 available from Materials Data, Inc. have helped to more efficiently compare an unknown material X-ray powder diffraction pattern to those in a library of known patterns, but the sheer volume of X-ray powder diffraction patterns being generated in a combinatorial chemistry application is likely to overwhelm the standard historical procedure.

This application builds on the foundation for automation that began with the pattern recognition or search and match programs and increases the degree of automation through the application of statistical algorithms. Hierarchical clustering analysis is used to determine clusters of X-ray powder diffraction patterns and, consequently, the materials that are structurally similar. The X-ray powder diffraction pattern of one representative material of the cluster may be further interpreted to discover the structural identity of the material. Depending upon the application and to conserve resources and time it may be sufficient to know that the remaining X-ray powder diffraction patterns of the cluster represent materials that are similar in structure to the one representative material that was further analyzed. Available resources may be conserved for those materials that are different and have a better likelihood of being novel. A more specific embodiment of the invention applies a search and match algorithm to all the X-ray powder diffraction patterns in one cluster to determine several likely structural identities of the materials. Correspondence factor analysis is applied to the tabulated results of the search and match algorithm to best predict the likely structural identities of all the materials in the cluster.

Clustering methods have been applied to data in the health related fields such as in U.S. Pat. No. 5,739,000 B1 and Thielemans, A., Lewi, P. J., Massart, D. L. Chemometrics and Intelligent Laboratory Systems, 3 (1988) 277-300. Clustering methods have also been applied in other analytical data such as near infrared spectroscopy; see U.S. Pat. No. 5,822,219 B1. Particular clustering methods have also been used as part of a process to determine the concentration of controlled substances such as heroin and cocaine when present in a mixture with other known compounds; see, Minami, Y.; Miyazawa, T.; Nakajima, K.; Hida, H.; X-sen Bunseki no Shinpo, 27 (1996) 107-115; Mitsui, T.; Okuyama, S.; Fujimura, Y. Analytical Sciences, 7 (1991) 941-945, and Harju; Minkkinen; Valkonen; Chemometrics and intelligent Laboratory Systems, 23 (1994) 341-350. In Mitsui et el., for example, the clustering methods were applied only to selected predetermined peaks of the X-ray diffraction patterns of materials where the identity of all the components making up the materials were known. No identification of the materials was necessary. What was being determined was the ratio of two known components in the materials. A set of mixtures having specific ratios of the known components were prepared and X-ray diffraction patterns obtained. The X-ray diffraction pattern of a material having an unknown ratio of components was also obtained. The same 18-19 peaks were selected from each of the patterns. Hierarchical clustering analysis was used to determine which of the set of selected 18-19 peaks from patterns of the known ratio materials was the closest match to the selected 18-19 peaks of the X-ray diffraction pattern corresponding to one material of an unknown ratio. The hierarchical clustering analysis was repeated for each and every material of unknown ratio. Ratios of the previously-identified components of the mixtures were thereby determined.

In contrast, applicant's invention allows for efficient management and interpretation of a large number of X-ray powder diffraction patterns through the use of the statistical tools of hierarchical clustering analysis and correspondence factor analysis. Using hierarchical clustering analysis allows for a large set of X-ray powder diffraction patterns to be clustered into subsets of similar materials, thereby reducing the overall number of X-ray powder diffraction patterns that must be interpreted by comparison to known libraries of X-ray powder diffraction patterns using, for example, search and match-type software programs. It is important to note that in applicant's invention, the aggregate of multiple materials under investigation are collectively subjected to the clustering analysis. The invention actively compares materials under investigation to one another and not merely to one or more prepared references of known identity or reference mixtures of known ratios. Inspection of the clusters formed may also indicate outliers corresponding to X-ray powder diffraction patterns that exhibit unusual characteristics as compared to the overall set of materials. A chemist may then focus attention on the X-ray powder diffraction patterns most likely to be a desired new chemical compound without spending resources on clusters that appear to be multiple materials of the same known structure. The dendrogram may reveal that of the multiple X-ray powder diffraction patterns, only a few should be investigated further. The time and labor savings to a chemist may be enormous. Furthermore, applicant's invention allows for more definite identification of the chemical or structural identity of materials in a cluster using search and match algorithms followed by correspondence factor analysis of the search and match results.

### SUMMARY OF THE INVENTION

The goal of the invention is to provide a method of rapidly identifying multiple X-ray powder diffraction patterns. The invention involves first obtaining an X-ray powder diffraction pattern of each member in a set of materials. The set of materials contains at least two materials of unknown identity. Then clusters of materials having similar structures are determined by applying hierarchical clustering analysis simultaneously to the aggregate of complete X-ray diffraction patterns. The structure is determined for at least one material in at least one cluster by comparing the X-ray powder diffraction pattern of the material to X-ray powder diffraction patterns in a library of known structures. The structure determined for at least one material in a cluster is then extrapolated to apply to all the materials of the cluster.

In a more specific embodiment of the invention, at least the two most likely structures, or “matches”, are determined for each X-ray powder diffraction pattern in a cluster using an algorithm that compares the X-ray powder diffraction pattern from the cluster to X-ray powder diffraction patterns in a library of known structures. All of the sets of at least two matches for the X-ray powder diffraction patterns are then subjected to correspondence factor analysis to provide a graphical summary of all the matches. The resulting graph and tables are interpreted to determine the single most likely structures of the cluster.

### BRIEF DESCRIPTION OF THE DRAWINGS

FIG. 1 is a dendrogram resulting from hierarchical clustering analysis of the X-ray powder diffraction patterns of one hundred and forty two zeolite materials

FIG. 2 shows the X-ray powder diffraction patterns of materials that fall into a single cluster of FIG. 1.

FIG. 3 shows the X-ray powder diffraction patterns of materials that fall into several different clusters of FIG. 1.

FIG. 4 is a dendrogram of Cluster A of FIG. 1.

FIG. 5 is a two-dimensional graph resulting from applying correspondence factor analysis to the results of the search and match algorithm performed on the materials of Cluster A.

### DETAILED DESCRIPTION OF THE INVENTION

This invention is applicable to any set of chemical compounds whose crystalline phase, i.e., structure, may be analyzed by X-ray powder diffraction. The nature of the chemical reaction used to produce the compounds being analyzed is not critical. The invention provides the greatest benefit, however, when large numbers of chemical compounds are being synthesized and require rapid analysis such as in a combinatorial chemistry application. For example, in a combinatorial chemistry application, chemical compounds may be generated in a set of 48, 96, or even 384 compounds simultaneously. Just a few combinatorial chemistry experiments may result in 1000 or more materials to analyze. A preferred analytical method in general use to identify unknown structures is X-ray powder diffraction. However, X-ray powder diffraction patterns are generally complex and require significant time and skill to interpret. The generation of 1000 or more chemical compounds for analysis on a daily basis, or even a weekly basis, would easily overwhelm most analytical laboratories. The basic features of our process are that (1) a significant amount of information about the chemical compounds may be generated rapidly using statistical analyses without the need for manually interpreting each individual X-ray powder diffraction pattern to determine the structural identity of each material being investigated and (2) the structural identity of materials in a selected cluster may be determined with a greater degree of certainty using search and match algorithms with the results of the search and match algorithms being subjected to correspondence factor analysis.

The process of the invention begins by taking X-ray powder diffraction patterns of all the materials in a set. X-ray powder diffraction techniques are well known in the art and will not be discussed in detail here. Greater detail may be found in texts such as Whiston, C, X-Ray Methods; Prichard, F. E., Ed.; Analytical Chemistry by Open Learning; John Wiley & Sons; New York, 1987, and X-Ray Spectrometry; Herglotz H. K., Birks, L. S. Eds.; Practical Spectroscopy Series, Vol. 2; Marcel Dekker: New York, 1978. The X-ray technique or instrumentation used is not critical to the success of the invention, but it is preferable that for a given set of materials, the same X-ray technique and instrumentation be used for each material in the set, such as measured over the same angular ranges and at the same increments.

The X-ray powder diffraction pattern of any material is generally expressed as a two-dimensional representation of the intensity of the diffracted X-ray radiation at a particular 2θ vs. the 2θ value. That is, one axis represents intensity, the other 2θ. When dealing with a set of materials where all the materials have a known identity, specific peaks may be selected to represent the most distinctive portion of the pattern. Additional manipulations may be conducted on those selected peaks alone (see Mitsui et al. supra). If the identity of the materials had not been previously determined, any selection of specific peaks to represent the X-ray diffraction pattern would be completely arbitrary. In the present invention, since the identity of many of the materials have not been previously determined, the complete or entire X-ray powder diffraction patterns are used. The term “complete” as describing X-ray diffraction patterns, is meant herein as all data collected within the 2θ that is selected. The data collected includes peak intensity and peak position. The “complete” pattern is referenced to distinguish from the situations where only pre-selected peaks are considered.

The aggregate of the complete patterns are simultaneously subjected to the well-known statistical technique of hierarchical clustering analysis available in numerous software packages including Pirouette from Infometrix, Inc., and Minitab from Minitab, Inc. The set of complete pattern vectors includes those from at least two materials being investigated, i.e., materials whose structure is not pre-determined. It is more preferred that the set of patterns include those from at least 6, 8 10, 25, 50 or 100 materials being investigated. The greatest benefit from the present invention is derived from situations where patterns from a larger number of materials being investigated are compared to one another, such as at least 200, 500, 1,000, 5,000 or 10,000 materials. Hierarchical clustering analysis which is applied simultaneously to the set of complete patterns involves joining together objects into successively larger clusters using some measure of similarity or distance. Results are often displayed in hierarchical trees or dendrograms. Various different methods of measuring the similarity or distance between objects, sometimes termed “(dis)similarity” may be used, and examples include, Euclidean distance, squared Euclidean distance, city-block distance, Chebychev distance, power distance, percent disagreement, and others. Similarly, various different methods are used to link clusters together, such as nearest neighbor, furthest neighbor, complete linkage, unweighted pair-group average, weighted pair-group average, unweighted pair-group centroid, and Ward's method. Further discussion of known methods of hierarchical clustering analysis may be found in Massart, D. L.; Vandeginste, B. G. M.; Deming, S. N.; Michotte Y.; Kaufman, L. Chemometrics: a textbook; Data Handling in Science and Technology—Vol. 2; Elsevier: New York, 1988.

Although any of the above methods may be used in the present invention, a preferred hierarchical clustering analysis uses a “nearest-neighbor” method for grouping similar X-ray powder diffraction patterns. The distance between two different patterns is preferably defined as the sum of the differences in intensities between the two patterns at each 2θ. The X-ray powder diffraction pattern of the material is then expressed in terms of the similarities. It is the similarities that exhibit clusters that may be visually depicted on a dendrogram. The nature of the material itself need not be known; what is important is that the X-ray powder diffraction patterns of the materials be measured, that the similarities of the set of the X-ray powder diffraction patterns be determined, and that clustering of the similarities be noted. It is generally helpful to determine the similarities/differences and the resulting clusters using computer software. Suitable software includes program packages such as Pirouette from Infometrix, Inc. and Minitab from Minitab, Inc. In most circumstances the same software packages may be used to generate the dendrogram.

The similarities determined may be observed by an analytical chemist for the formation of clusters, but it is contemplated that other algorithms may be used to analyze the data for clusters and provide dendrograms. A surprising amount of information is gathered from the determination of the similarities and resulting clusters. For example, the smaller the determined difference between two materials, or the closer the cluster, the more similar the two materials are to one another. Similar materials cluster together, as shown on a dendrogram, and if the identity of one of the materials in that cluster is known, then the identity of the materials in the rest of the cluster is also inferred with a degree of certainty based on the level of similarity. The time and labor savings from determining clusters can be enormous. For example, in the case where 100 materials are subjected to the process of the invention as described above and the resulting differences fall into three clusters, only three of the X-ray powder diffraction patterns need to be further processed using search and match type programs in combination with a library of known X-ray powder diffraction patterns (discussed below). The results of the first search and match routine can be extrapolated to each of the X-ray powder diffraction patterns in the cluster from which the first representative X-ray powder diffraction pattern was taken. The results of the second search and match routine can be extrapolated to each of the X-ray powder diffraction patterns in the cluster from which the second representative X-ray powder diffraction pattern was taken, and so on. For the time and effort needed to particularly identify three X-ray powder diffraction patterns, the identity of all 100 materials can be estimated with reasonable certainty.

In a specific embodiment of the invention, to aid in identifying the chemical or structural nature of a cluster, known materials may be contained as part of the set of materials. The known materials are analyzed as part of the set along with the rest of the unknown materials being investigated as described above. The similarity of the known materials as compared to the unknown materials would help to identify clusters or outliers. For example, if a known material lies in a particular cluster, it is a good indication that the rest of the unknown materials in that cluster have a structural identity very close to that of the known material. Again, it must be emphasized that multiple materials whose identity are not known or predetermined are also included within the set of materials whose X-ray diffraction patterns are subjected to hierarchical clustering analysis. The patterns of unknown materials are clustered with each other as well as to perhaps references that may be present.

Equally as important as determining those materials that fall within a cluster is the opportunity for an analyst to single out and focus on those materials whose similarity values do not fit into any of the clusters. Such data points are usually termed “outliers”. Outliers are generally either new materials or perhaps faulty data. In either case, these few outlier materials can be studied in more detail while a majority of the materials can be safely assigned to known categories. Again, the potential time and labor savings to an analyst can be significant. Those X-ray powder diffraction patterns offering the greatest potential are identified and may be focused on without expending resources on less promising X-ray powder diffraction patterns.

As discussed above, once a cluster has been formed, the structure of the materials in the cluster may be further investigated using search and match programs in combination with a library of known X-ray powder diffraction patterns. Search and match software packages are readily available and an example of suitable software is Jade available from Materials Data, Inc., Livermore California. Similarly, libraries or databases of known X-ray powder diffraction patterns are also readily available and suitable examples include Powder Diffraction Files of the International Centre for Diffraction Data. Search and match methods however are merely tools and provide possible identities of a material based upon the comparison of the material X-ray powder diffraction pattern with known patterns. The search and match method may result in a number of possible identities or structures being suggested, perhaps with a confidence value or ranking associated with each suggestion. The present invention applies statistical analyses to the set of search and match results corresponding to a set of materials whose similarities form a cluster in order to more reliably arrive at a structural identification of the materials forming the cluster.

A cluster is selected and each X-ray powder diffraction pattern in the cluster is subjected to a search and match program where the material X-ray powder diffraction pattern is compared to a library of known X-ray powder diffraction patterns. At least the two most likely identifications or matches for each material making up the cluster are noted. The identifications are generally directed to the primary structure present in the material. In particular applications, as many as six most likely identifications or matches for each material may be noted. A known statistical method, correspondence factor analysis, is then applied to the set of most likely identifications of the materials in the cluster. Correspondence factor analysis is a method by which the similarity of the materials and possible identifications can be simultaneously represented in a graph and is a variation of principal component analysis applied to contingency tables. In this application, the contingency table is the count of materials in each identification and order. The algorithm partitions the observed counts of order and identification into linear combinations which explain most of the variability, called principal axes. The correspondence factor analysis performs an eigen analysis of the set of data and variability is broken down into underlying dimensions and associated with rows and/or columns. It is particularly suited to summarizing cross-tabulations that count the prevalence of several phenomena in different groups.

The correspondence factor analysis partitions not the total variance, as in principal component analysis, but the Pearson chi-square statistic, or chi-square/n. The statistical method of correspondence factor analysis may be performed using any number of commercially available software packages such as Minitab available from Minitab, Inc. As discussed above, the correspondence factor analysis results in a plot that may be visually inspected. The plot is defined by principal components or principal axes. The first principal axis is chosen so that it accounts for the maximum variation in frequency of occurrence; the second principal axis is chosen so that it accounts for the maximum amount of the remaining maximum variation in frequency of occurrence; and so on. The position of data points on the plots are meaningfully interpreted in terms of the interaction between rows and columns of a table. The proximity between data points for order and identification indicate that the relative frequencies of materials with the indicated order and frequency are similar. For example, patterns of identification order with high relative frequencies across materials are attached by those variables and are located close together on the plot.

Without intending any limitation on the scope of the present invention and as merely illustrative, one specific example of this invention is provided below in specific terms as applied to a specific embodiment of the invention. The example clearly shows the methodology and the benefits of the approach described herein.

### EXAMPLE

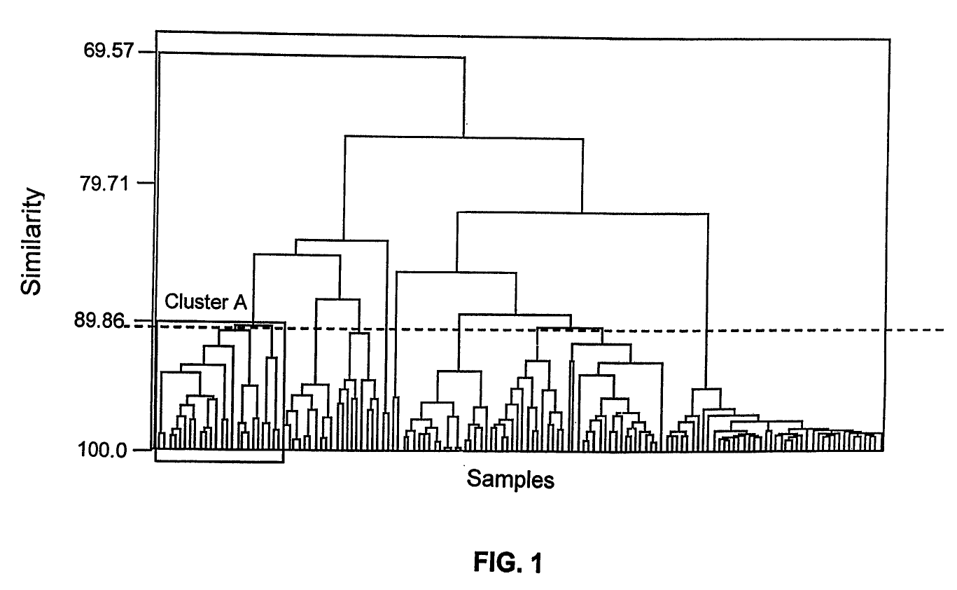

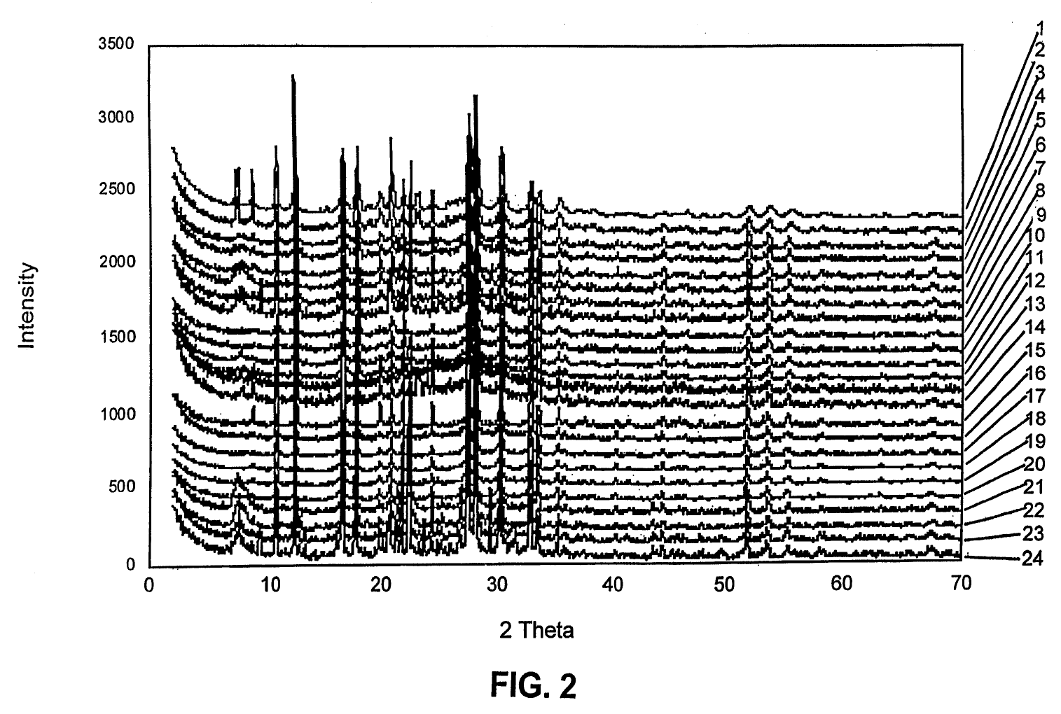

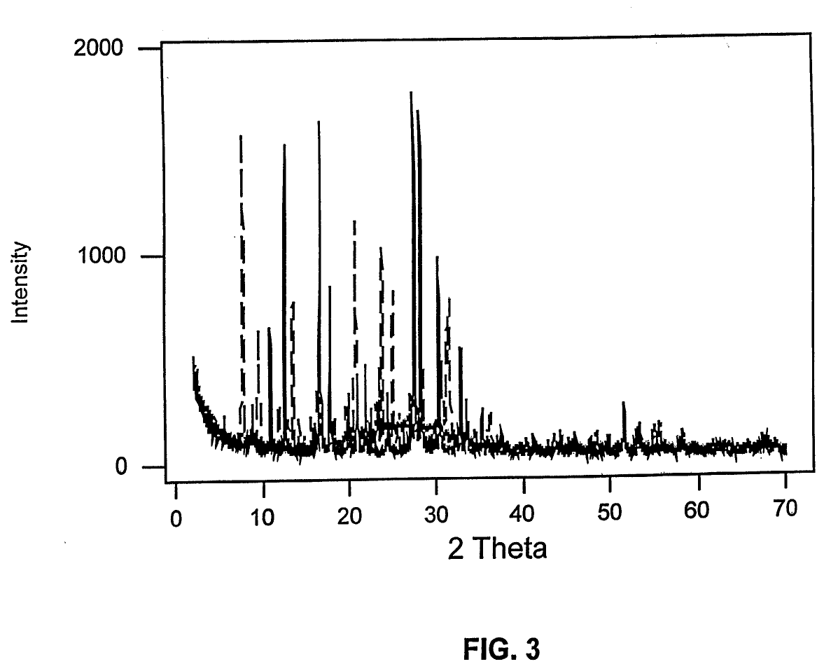

One hundred and forty-two zeolite materials were selected and the X-ray powder diffraction pattern was obtained for each material in the material set using standard X-ray powder diffraction techniques. The diffractometer used was a Brucker AXS D8 Advance with a high intensity X-ray tube radiation source operated at 40 kV and 40 ma. The diffraction pattern from the copper K-alpha radiation was obtained by approximate computer based techniques. Flat powered materials were continuously scanned at 3.6° (2^{θ})/min from 5′ to 40° (2^{θ}). Each X-ray diffraction pattern is comprised of the intensities and positions of peaks occurring in the scanned 2θ range. The entire set of complete X-ray powder diffraction patterns (each pattern comprising all of the intensities and positions of peaks occurring in the scanned 2θ range) corresponding to the one hundred and forty-two zeolite materials was then simultaneously analyzed using hierarchical clustering analysis to determine whether similarities among the materials formed clusters. The similarities were determined based upon the sum of the squared differences at each 20 using unweighted fill patterns and the average distance between all pairs of materials from each cluster. FIG. 1 shows the resulting dendrogram indicating that nearly 70% of the 142 full X-ray powder diffraction patters are similar, and that there are 9 clusters for 90% similarity. FIG. 2 shows the X-ray powder diffraction patterns of materials that fall within a single cluster, while FIG. 3 shows several X-ray powder diffraction patterns of materials that fall in a variety of clusters. A comparison of FIG. 2 and FIG. 3 clearly shows that the X-ray powder diffraction patterns of materials that fall within a single cluster look similar, while the X-ray powder diffraction patterns of materials that fall in a variety of clusters look diverse with peaks occurring at different theta values.

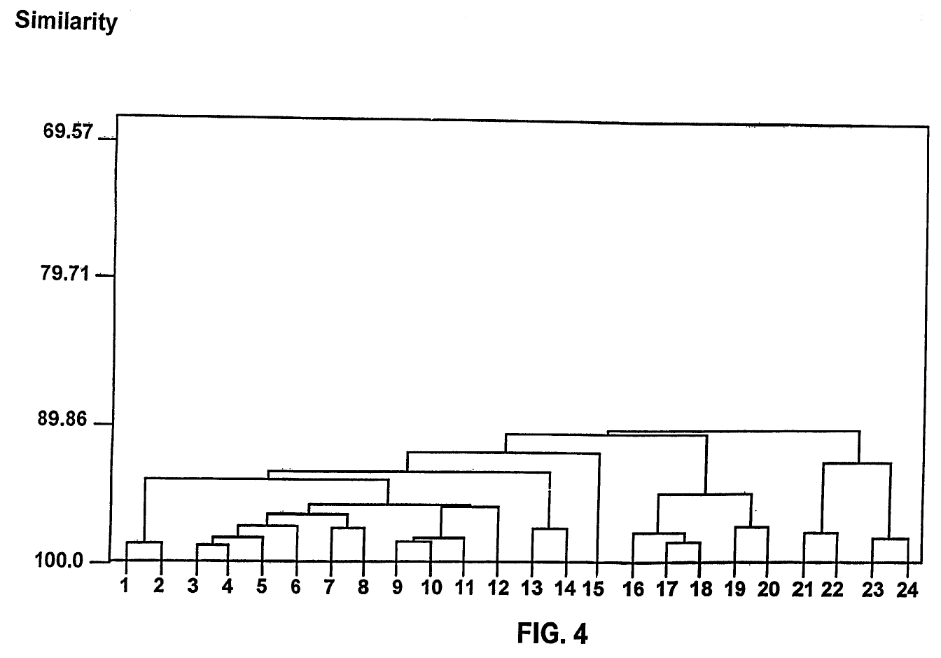

One cluster, Cluster A of FIG. 1, was selected for further investigation and is shown in the dendrogram of FIG. 4. Cluster A contains 24 materials with 90% similarity. The search and match program, WinJade, was applied to the X-ray powder diffraction patterns of the materials in cluster A to identify up to the six best matches for each material in the cluster. The matches are tabulated in the table. Zeolite designations are according to the standards set by the Structure Commission of the International Zeolite Association, see Meier, W. M.; Olson, D. H.; Baerlocher Atlas of Zeolite Structure Type, 4th Revised Ed.; Rees, V. C., von Ballmoos, R. Eds.; Published on Behalf of the Structure Commission of the International Zeolite Association; Elsevier: New York, 1996.

| | TABLE | | | | | | |
|---|---|---|---|---|---|---|---|
| | MATERIALS MATCH | | | | | | |
| IDENTITY | 1 | 2 | 3 | 4 | 5 | 6 | All |
| MER | 21 | 18 | 8 | 4 | 2 | 1 | 54 |
| TRI | 0 | 2 | 2 | 4 | 5 | 2 | 15 |
| BEA | 0 | 1 | 2 | 0 | 2 | 3 | 8 |
| PHI | 0 | 0 | 5 | 4 | 4 | 0 | 13 |
| SGT | 0 | 0 | 1 | 0 | 0 | 0 | 1 |
| EMT | 0 | 0 | 1 | 0 | 0 | 0 | 1 |
| AWW | 0 | 0 | 1 | 0 | 0 | 0 | 1 |
| LIO | 0 | 0 | 0 | 2 | 1 | 2 | 5 |
| AST | 0 | 0 | 0 | 1 | 0 | 0 | 1 |
| AlAs | 0 | 0 | 0 | 1 | 0 | 2 | 3 |
| GOO | 0 | 0 | 0 | 1 | 0 | 0 | 1 |
| SSZ-45 | 0 | 0 | 0 | 1 | 0 | 0 | 1 |
| APC | 0 | 0 | 0 | 1 | 1 | 0 | 2 |
| GIS | 0 | 0 | 0 | 1 | 0 | 1 | 2 |
| SSZ-47 | 0 | 0 | 0 | 0 | 1 | 0 | 1 |
| ECR-1 | 0 | 0 | 0 | 0 | 1 | 0 | 1 |
| LOI | 0 | 0 | 0 | 0 | 1 | 0 | 1 |
| LZ-135 | 0 | 0 | 0 | 0 | 0 | 1 | 1 |
| BER | 0 | 0 | 0 | 0 | 0 | 1 | 1 |
| MEL | 0 | 0 | 0 | 0 | 0 | 1 | 1 |
| ROG | 0 | 0 | 0 | 0 | 0 | 1 | 1 |
| All | 21 | 21 | 20 | 20 | 18 | 15 | 115 |

MER is the most common identification with TRI, BEA and PHI also being frequent alternatives.

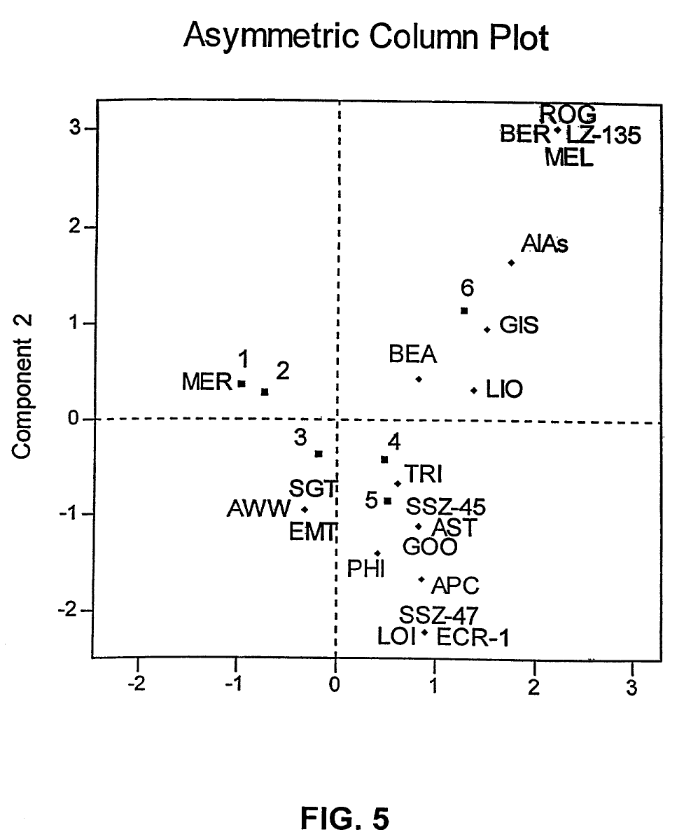

Correspondence factor analysis was applied to the tabulated results of the search and match analysis, and the correspondence factor analysis results were plotted as shown in FIG. 5 which represents a symmetrical plot summarizing trends in both identifications and order. The axes represent the first and second principal axes, so this is the two-dimensional graph which best explains the frequency and order of identifications made for the group. Factor 1 is the first principal axis representing the linear combination which best contrasts the relative frequency of different identifications. Factor 2 is the second principal axis which best explains the remaining variations in the frequency of different identifications. Distance between order and identification on the plot approximates the probability that the order of an identification is random; where the number designating order is close to an identification, the identification is most likely to occur in that order. By inspection of FIG. 5, MER w was the first and second identification for most materials, and can be accepted as the most likely identity of all the materials in this cluster. The zeolite designation MER is defined according to the standards set by the Structure Commission of the International Zeolite Association, see Meier, W. M.; Olson, D. H.; Baerlocher Atlas of Zeolite Structure Type, 4th Revised Ed.; Rees, V. C., von Ballmoos, R. Eds.; Published on Behalf of the Structure Commission of the International Zeolite Association; Elsevier: New York, 1996, p. 144-145.

1) A method of analyzing a set of materials comprising at least ten unknown materials to determine the structure of each of the unknown materials in at least one cluster of materials comprising:
a) obtaining the complete X-ray powder diffraction pattern of each member in the set of materials;
b) applying, simultaneously, hierarchical cluster analysis to the aggregate of the complete X-ray powder diffraction patterns thereby forming clusters;
c) identifying the structure of at least one material in at least one cluster by comparing the X-ray powder diffraction pattern of at least one material to the X-ray powder diffraction patterns of known structures; and
d) assigning the structure identified for at least one material to all the materials in that same cluster.

2) The method of claim 1 wherein the set of materials contains unknown materials in a quantity selected from the group consisting of at least 25, 50, 100, 200, 500, 5000, 1000, and 10,000, materials.

3) The method of claim 1 wherein at least one of the complete X-ray diffraction patterns corresponds to a material in the set of materials that has a known structure.

4) The method of claim 1 wherein the structure is identified for at least one material of a first cluster and at least one material of a second cluster by comparing the X-ray powder diffraction pattern of each material to X-ray powder diffraction patterns of known structures, and assigning the structure identified for the material of the first cluster to all materials in the first cluster, and assigning the structure identified for the material of the second cluster to all materials in the second cluster.

5) A method of analyzing a set of materials comprising at least ten unknown materials to determine the structure of each of the unknown materials in at least one cluster of materials comprising:
a) obtaining the complete X-ray powder diffraction pattern of each member in the set of materials;
b) applying, simultaneously, hierarchical cluster analysis to the aggregate of the complete X-ray powder diffraction patterns thereby forming clusters;
c) estimating from about two to about six most probable structures for each material in a cluster by applying a search and match algorithm to each complete X-ray powder diffraction pattern in the cluster to generate tabulated results; and
d) determining the single most probable structure of the materials in a cluster by applying correspondence factor analysis to the tabulated results of search and match algorithm.

6) Previously Presented) The method of claim 5 wherein at least one of materials in the set of materials has a known structure.

7) The method of claim 5 wherein steps (c) and (d) are repeated for additional clusters.

8) The method of claim 5 wherein the set of materials contains unknowns in a quantity selected from the group consisting of at least 25, 50, 100, 200, 500, 5000, 1000, and 10,000, materials.
